(19) United States
(12) Patent Application Publication
(10) Pub. No.: US 2002/0080559 A1
(43) Pub. Date: Jun. 27, 2002

(54) Capacitor and method of producing same

(76) Inventors: Seiji Nonaka, Ibaraki-shi (JP); Nario Niibo, Katano-shi (JP); Masakazu Tanahashi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/017,386

(22) Filed: Dec. 18, 2001

Related U.S. Application Data
(62) Division of application No. 09/587,255, filed on Jun. 2, 2000.

(30) Foreign Application Priority Data
Jun. 4, 1999 (JP) P 11-157879

(51) Int. Cl. H01G 4/06; H01G 9/00

(52) U.S. Cl. 361/524

(57) ABSTRACT

A capacitor includes an anode foil having an anode foil dielectric film deposited thereon by anodic oxidation; an anode lead member including a first metal core with roughness and an anode lead dielectric film deposited on the roughness by anodic oxidation, said anode lead member being electrically connected to the anode foil; a cathode foil opposing to the anode foil interposing a separator between them; a cathode lead member being electrically connected to the cathode foil; and a container filled up with an electrolyte and containing the anode foil, anode lead member, cathode foil and cathode lead member therein. The anodizing voltage employed during anodic oxidation to form the anode lead dielectric film is equal to or higher than about 70% of that used to form the anode foil dielectric film.

### BACKGROUND OF THE INVENTION

1. Field of the Invention

The present invention relates to a capacitor including an anode foil and a cathode foil opposed to each other via a separator positioned therebetween, and to a method of producing the same.

2. Description of the Related Art

FIG. 3 shows a conventional snap-in type aluminum electrolytic capacitor 30 comprising a capacitor element 34 housed in a container 9 with an opening of the container 9 being sealed with a sealing body 6. The container 9 is filled with an electrolyte with the capacitor element 34 impregnated in the electrolyte. The capacitor element 34 includes an anode foil and a cathode foil both wound with a separator 36 interposed therebetween, and is provided with an anode lead member 35a and a cathode lead member 35b. The anode lead member 35a and the cathode lead member 35b are connected to external terminals 8 via respective rivets 7 fitted in the sealing body 6.

The anode foil is made by roughing one surface of an aluminum plain foil to increase the surface area thereof and then forming a dielectric film on the roughened surface through an anodizing process. Connected to the anode foil made as described above at a predetermined position thereof is the anode lead member that is made by forming a dielectric film on the aluminum plain foil. The dielectric film is thus formed on the roughened surface of the anode foil and also on the surface of the flat anode lead member.

The cathode foil is similarly formed by roughing one surface of an aluminum plain foil to a predetermined surface irregularity. Connected to the cathode foil at a predetermined position thereof is the cathode lead member made of the aluminum plain foil.

The conventional electrolytic capacitor of the type described above, however, has such problems as described below. Continuous application of an electric voltage to the capacitor tends to result in the capacitor being excessively loaded to such an extent that cracking may occur in the dielectric film. The crack leads to partial exposure of the aluminum plain foil and in turn allows current to leak from the exposed plain foil of the anode foil to the cathode foil through the electrolyte that is soaked in the separator. Then, the electrolyte is electrolyzed by the leak current that flows therein, resulting in precipitation of a dielectric film on the surface of the exposed plain foil to thereby restore the broken dielectric film. At this time, obnoxious gases are generated as the electrolyte is electrolyzed.

Another problem is that, in the capacitor in which both the anode foil and the cathode foil have a dielectric film formed on the surface thereof, similarly obnoxious gases tend to be generated when the dielectric films break. Attempts have been made in the past to avoid the gas generation, particularly by improving the dielectric film on the anode foil, but they are not successful in preventing the gas generation.

### SUMMARY OF THE INVENTION

The present invention has therefore been made to solve the problems described above, and an object thereof is to provide a capacitor wherein the leak current is decreased to reduce the amount of obnoxious gases generated, and also to provide a method of producing the same.

The inventors of the present invention have intensively studied about the problems described above and obtained the following findings. When an anode lead member is made by forming a dielectric film on an aluminum plain foil, the dielectric film so formed on the surface of the anode lead member is susceptible to cracking. This is because the dielectric film formed on the smooth surface of the aluminum plain foil is not stable. Since the anode lead member is immersed in the electrolyte in the capacitor, breakage and restoration occur on the dielectric film on the surface of the anode lead member as is the case with that occurring on the dielectric film on the surface of the anode foil. As a result, the gases are generated when the dielectric film on the surface of the anode lead member is broken or restored. It has been found that the quantity of the gases generated when the dielectric film on the surface of the anode lead member is broken or restored amounts to about 20 to 30 times that generated when the dielectric film on the surface of the anode foil is broken or restored. This means that the generation of gases is mostly caused by the breakage of the dielectric film of the anode lead member. It has also been found that the dielectric film of the anode lead member is more prone to breakage than the dielectric film on the surface of the cathode lead member.

The present invention has been based on the result of the studies conducted by the inventors as described above.

According to one aspect of the invention, a capacitor comprises an anode foil having an anode foil dielectric film deposited thereon by anodic oxidation; an anode lead member including a first metal core with roughness and an anode lead dielectric film deposited on the roughness by anodic oxidation, the anode lead member being electrically connected to the anode foil; a cathode foil opposing to the anode foil with a separator interposed therebetween; a cathode lead member being electrically connected to the cathode foil; and a container filled with an electrolyte and containing the anode foil, anode lead member, cathode foil and cathode lead member therein. An anodizing voltage used during the anodic oxidation for forming the anode lead dielectric film is equal to or higher than about 70% of that used during the anodic oxidation to form the anode foil dielectric film.

Since the anode lead member including a first metal core with roughness (that is, surface area of the first metal core is increased) and an anode lead dielectric film deposited on the roughness, the anode lead dielectric film is firmly deposited on the surface of the metal foil, and the anode lead dielectric film is less likely to crack. Also because the anodizing voltage used for forming the anode lead dielectric film is equal to or higher than about 70% of that for forming the anode foil dielectric film, the dielectric film having a sufficient thickness is formed on the surface of the anode lead member. Thus, the anode lead dielectric film is less susceptible to cracking. As a result, the leak current can be suppressed thereby reducing the gas generation. As used herein, the term “anodic oxidation” refers to an electrochemical process of depositing the dielectric film on the metal foil in the electrolyte. The voltage used during the anodization is called the anodizing voltage. Thickness of the dielectric film that is formed varies depending on the amount of the anodizing voltage, although the amount of the anodizing voltage have a proportional relation with the thickness of the dielectric film.

Preferably, the anodizing voltage for forming the anode lead dielectric film is equal to or higher than about 80% of that for forming the anode foil dielectric film. This is effective to allow the anode lead dielectric film to be more firmly deposited on the surface of the metal foil, and also to minimize the possibility of the anode lead dielectric film cracking.

If the cathode foil has a cathode foil dielectric film deposited thereon and the cathode lead member includes a second metal core with roughness and a cathode lead dielectric film deposited on the roughness, the highly durable capacitor can be obtained.

According to another aspect of the invention, a capacitor comprises: an anode foil having an anode foil dielectric film deposited thereon by anodic oxidation; an anode lead member including a first metal core with roughness and an anode lead dielectric film deposited on the roughness by anodic oxidation, anode lead member being electrically connected to the anode foil; a cathode foil opposing to the anode foil interposing a separator therebetween; a cathode lead member including a second metal core with roughness and a cathode lead dielectric film deposited on the roughness by anodic oxidation, the cathode lead member being electrically connected to the cathode foil; and a container filled up with an electrolyte and containing the anode foil, anode lead member, cathode foil and cathode lead member therein.

Since the anode lead member includes a first metal core with roughness and the anode lead dielectric film deposited on the roughness by anodic oxidation and the cathode lead member includes the second metal core with roughness and the cathode lead dielectric film deposited on the roughness by anodic oxidation, both the anode lead dielectric film and the cathode lead dielectric film are unlikely to be broken. As a result, the leak current can be suppressed thereby reducing the gas generation.

It is preferable that the voltage of the anodic oxidation for forming the anode lead dielectric film is greater than or equal to about 70% of that for the anode foil dielectric film.

It is more preferable that the voltage of the anodic oxidation for forming the anode lead dielectric film is about 80% or more than that for the anode foil dielectric film.

It is preferable that first and second metal core with roughness are produced by using at least one selected from the group consisting of electrolytic etching method, chemical etching method and blasting method.

According to yet another aspect of the invention, a method of producing a capacitor, comprises the steps of: a) preparing an anode foil having an anode foil dielectric film deposited thereon by anodic oxidation; b) roughening a first metal core; c) depositing an anode lead dielectric film on the first metal core by anodic oxidation so as to form an anode lead member; d) electrically connecting the anode lead member with the anode foil; e) opposing a cathode foil to the anode foil interposing a separator therebetween; f) electrically connecting a cathode lead member with the cathode foil; and g) immersing the anode and cathode foil, and the anode and cathode lead member within a container filled up with an electrolyte. The voltage of the anodic oxidation for forming the anode lead dielectric film is greater than or equal to about 70% of that for forming the anode foil dielectric film.

Since the first metal core is roughened and the anode lead dielectric film is deposited on the first metal core by anodic oxidation so as to form an anode lead member, the anode lead dielectric film is firmly deposited on the surface of the metal foil, and the anode lead dielectric film is less likely to crack. Also because the voltage of the anodic oxidation for forming the anode lead dielectric film is greater than or equal to about 70% of that for the anode foil dielectric film, the dielectric film having a sufficient thickness is formed on the surface of the anode lead member. Thus the anode lead dielectric film is less likely to crack. As a result, the leak current can be suppressed thereby reducing the gas generation.

It is preferable that the voltage of the anodic oxidation for forming the anode lead dielectric film is greater than or equal to about 80% of that for forming the anode foil dielectric film.

The step (b), (d) and (c) may be carried out in this order.

The step (b) may be carried out after the step (d).

The step (b), (c) and (d) may be carried out in this order and a condition of the anode oxidation for forming the anode foil dielectric film is as same as that for forming the anode lead dielectric film.

It is preferable that the method of producing the capacitor further comprises the steps of: h) roughening a second metal core; and i) depositing a cathode lead dielectric film on the second metal core by anodic oxidation to form a cathode lead member.

The step (h), (f) and (i) may be carried out in this order.

The step (h) may be carried out after the step (f).

The steps (h), (i) and (f) may be carried out in this order and conditions of the anode oxidation for depositing the anode foil dielectric film, the anode lead dielectric film and the cathode lead dielectric film are the same.

It is preferable that the step (b) is carried out by using at least one selected from the group consisting of electrolytic etching method, chemical etching method and blasting method.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is an exploded perspective view of an electrolytic capacitor according to an embodiment of the present invention.

FIG. 2A shows an electrode foil and a lead member used in the electrolytic capacitor according to the embodiment of the present invention.

FIG. 2B is an enlarged schematic view of an anode lead member employed in the capacitor embodying the present invention;

FIG. 2C is a cross-sectional view taken along the line 2C-2C′ in FIG. 2B; and

FIG. 3 is a schematic sectional view of the conventional electrolytic capacitor.

### DETAILED DESCRIPTION OF THE PREFERRED EMBODIMENTS

This application is based on applications Nos. 11-157879 and 2000-162230 filed Jun. 4, 1999 and May 31, 2000, respectively, in Japan, the content of which is incorporated herein to by reference.

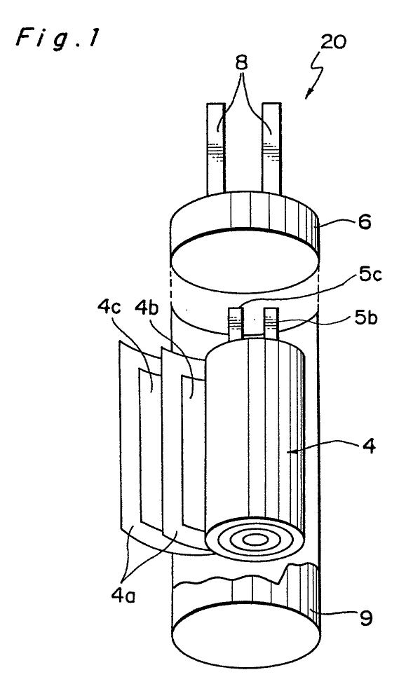

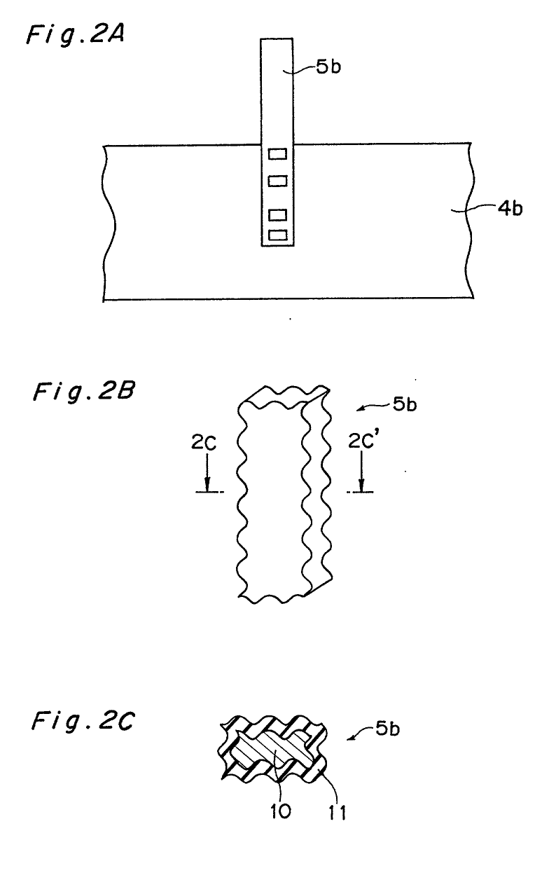

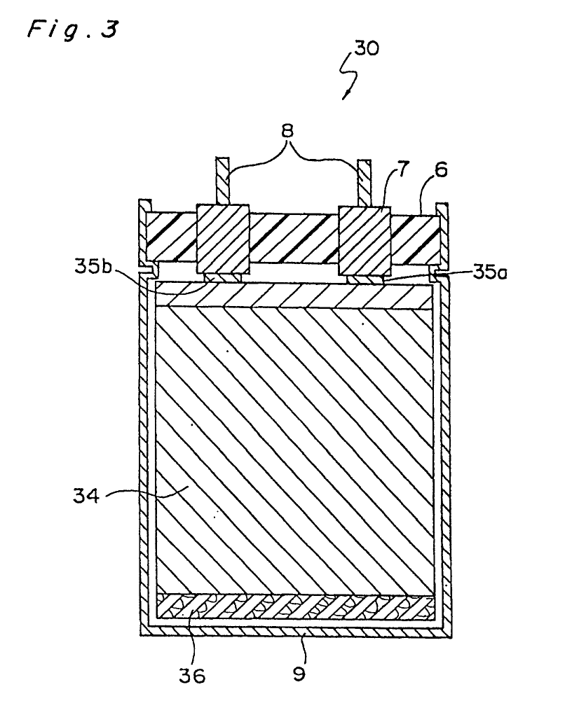

Preferred embodiments of the present invention will now be described below with reference to FIG. 1, FIG. 2A, FIG. 2B, and FIG. 2C.

### Embodiment 1

The capacitor according to the first embodiment is of a design in which a dielectric film formed and stabilized on the surface of an anode lead memberso that neither cracking nor any other faults is likely to occur. The capacitor 20 of the first embodiment comprises a capacitor element 4 housed in a container 9 that is filled up with an electrolyte (electrolytic solution) for operating the capacitor, with an opening of the container 9 being sealed with a sealing body 6 as shown in FIG. 1.

The capacitor element 4 comprises a roll made by winding respective lengths of anode and cathode foils 4b and 4c with a length of separator 4a interposed therebetween. The resultant roll, that is, the capacitor element 4 is impregnated with the electrolyte for operating the capacitor. The capacitor also comprises an anode lead member 5b and a cathode lead member 5c which are electrically connected with the anode foil 4b and the cathode foil 4c, respectively. The anode lead member 5b is connected to the anode foil 4b so as to extend vertically in a direction perpendicular to the longitudinal sense of the length of the anode foil 4b. The cathode lead member 5c is similarly connected to the cathode foil 4c so as to extend vertically in a direction perpendicular to the longitudinal sense of the length of the cathode foil 4c. The anode lead member 5b and cathode lead member 5c are in turn connected to external terminals 8 via respective ribets (not shown) fitted in the sealing body 6.

While the capacitor element 4 has been described in the form of a roll formed by winding the anode foil 4b and the cathode foil 4c with the separator 4a interposed therebetween, the present invention is not limited to this configuration and is applicable to any configuration as long as the anode foil and the cathode foil oppose each other with the intervention of the separator.

The anode foil 4b is made by forming a dielectric film on the surface of an aluminum foil and cutting it into predetermined dimensions. As shown in FIG. 2A, the anode lead member 5b is connected to the anode foil 4b at a predetermined position thereof, and is connected to the anode foil 4b so as to extend vertically in a direction perpendicular to the longitudinal sense of the anode foil 4b.

FIG. 2B is an enlarged schematic view of the anode lead member 5b, and FIG. 2C is a sectional view along line 2C-2C′ in FIG. 2B. As shown in FIG. 2B and FIG. 2C, the anode lead member 5b of the capacitor 20 according to the first embodiment is made by forming the dielectric film (anode lead dielectric film) on the surface of a metal core 10 that is employed in the form of an aluminum foil. The surface of the metal core 10 has been roughened to render the metal core 10 to have an increased surface area. As shown in FIG. 2C, the anode lead dielectric film 11 is formed along the roughened surface of the metal core 10. Roughening of the surface of the metal core 10 results in reduction of the area of a slippery surface of the metal core 10 and, therefore, the dielectric film 11 can be firmly interlocked with the surface of the metal core 10, thus making cracks unlikely to occur. The cracks that would occur in the dielectric film 11 formed on the surface of the metal core 10 are smaller than those of the dielectric film formed on the flat metal surface. Consequently, the dielectric film 11 formed on the roughened surface of the metal core 10 is less likely to crack and is stable.

The cathode foil 4c is made by forming a dielectric film (cathode foil dielectric film) on the surface of an aluminum foil and cutting it to predetermined dimensions, and the cathode lead member 5c is made by cutting an aluminum foil to predetermined dimensions. As is the case with the anode lead member 5b described above, the cathode lead member 5c is also connected to a predetermined position of the cathode foil 4c and is connected to the cathode foil 4c so as to extend vertically in a direction transverse to the longitudinal sense of the length of the cathode foil 4c.

In the capacitor 20 according to the first embodiment described above, since the anode lead 5b includes the metal core 10 having the roughened surface and the anode lead dielectric film is deposited on the roughened surface thereof, the anode dielectric film can be firmly and stably provided on the surface of the metal core. Thus, cracks do not occur in the anode lead dielectric film even when the anode lead member 5b is loaded as a result of the continuous application of a voltage across the capacitor, and an exposed portion of the metal core 10 in the anode lead member 5b that is electrically conductive does not make direct contact with the electrolyte. As a result, leak current does not flow between the anode lead member and cathode lead member through the electrolyte, thus preventing the obnoxious gases from being generated during electrolysis of the electrolyte brought about by the leak current.

A method of producing the capacitor 20 according to the first embodiment will be described below. First, anodic oxidation is applied to an aluminum foil that has been processed to have a roughened surface, followed by deposition of a dielectric film (anode foil dielectric film) on the roughened surface thereof. The aluminum foil is then cut to the predetermined dimensions to thereby provide the anode foil 4b. Anodic oxidation is similarly applied to an aluminum foil to form a dielectric film (cathode foil dielectric film) on the surface thereof, and the aluminum foil is then cut to the predetermined dimensions to thereby provide the cathode foil 4c.

While the dielectric films are formed on the anode foil 4b and the cathode foil 4c, respectively, for the capacitor 20 according to the first embodiment, the present invention is not limited to this configuration and the dielectric film may be formed only on the anode foil 4b. In case where the dielectric film is formed on the cathode foil, electrical stress generated when a ripple current flows through the capacitor can be absorbed, and durability of the capacitor can be increased.

Then, to make the anode lead member 5b, after the aluminum foil has been surface-roughened in the manner described above, the aluminum foil is cut to the predetermined dimensions. The cathode lead member 5c is made by cutting an aluminum foil to the predetermined dimensions.

Then the anode lead member 5b and the cathode lead member 5c are connected to the anode foil 4b and the cathode foil 4c, respectively, at the predetermined positions thereof. Although the anode foil dielectric film is present between the anode foil 4b and the anode lead member 5b, a part of the anode foil dielectric film is removed to allow the anode foil 4b and the anode lead member 5b to be staked and then connected thereto, thereby electrically connecting the anode lead member 5b with the anode foil 4b. The cathode lead member 5c and the cathode foil 4c are connected similarly. Thereafter, a dielectric film (anode lead dielectric film) is formed on the surface of the anode lead member 5b that is connected to the predetermined position of the anode foil 4b. Thus the anode lead member 5b that is connected to the anode foil 4b and has the anode lead dielectric film formed on the surface thereof is completed.

The anode foil 4b connected with the anode lead member 5b and the cathode foil 4c connected with the cathode lead member 5c are subsequently wound with the separator 4a interposed therebetween, to thereby complete the capacitor element 4. The resultant capacitor element 4 is housed in the container 9 so as to be immersed in the electrolyte within the container 9. Finally, the opening of the container 9 is sealed with the sealing body 6, thereby completing the capacitor 20.

The anode lead member 5b is surface-roughened before the anode lead member 5b is attached to the anode foil 4b in the method described above. However, the present invention is not limited to this method and the anode lead member 5b may also be surface-roughened after the anode lead member 5b has been attached to the anode foil 4b.

The dielectric film may also be formed on the surface of the anode lead member 5b before the anode lead member 5b is connected to the anode foil 4b to complete the anode lead member. In this case, the conditions under which the anodic oxidization is performed to form the dielectric film on the anode lead member and the conditions under which the anodic oxidization is performed to form the dielectric film on the anode foil are preferably identical with each other, so that the process of forming the anode lead dielectric film and the process of forming the anode foil dielectric film can be carried out using the same facilities, as will be described in conjunction with Example 3 below.

### Embodiment 2

The capacitor according to the second embodiment will be described below. The capacitor according to the second embodiment is different from the capacitor 20 of the first embodiment in that not only the anode lead member but also the cathode lead member is formed from an the aluminum foil that is surface-roughened.

The cathode lead member of the capacitor according to the second embodiment is made by forming the dielectric film (cathode lead dielectric film) of a surface-roughened metal foil. The anode lead dielectric film is formed on the roughened surface of the cathode lead member in a manner similar to the anode lead dielectric film 11 shown in FIG. 2B and 2C. By roughing the surface of the metal foil, the area of the slippery surface of the metal foil is decreased so that the cathode lead dielectric film and the surface of the metal foil can firmly and stably interlock with each other, thus making cracks unlikely to occur. The cracks that would occur in the cathode lead dielectric film are smaller than those of the dielectric film formed on a flat metal surface. Consequently, the cathode lead dielectric film formed on the roughened surface of the cathode lead member is less likely to crack and is stable.

In the capacitor according to the second embodiment, since the anode lead member includes the surface-roughened metal core (first metal core) and the anode lead dielectric film is deposited on the roughened surface thereof, and the cathode lead member includes the similarly surface-roughened metal core (second metal core) and the cathode lead dielectric film is deposited on the roughened surface thereof, the anode lead dielectric film and the cathode lead dielectric film can be firmly and stably deposited on the surfaces of the first and second metal cores, respectively. Thus, breakage of the dielectric films can be reliably suppressed even when a voltage is continuously applied across the capacitor. As a result, leak current can be suppressed thereby preventing the gas from being generated by electrolysis of the electrolyte by the leak current.

The cathode lead member of the capacitor according to the second embodiment can be made by a method similar to the anode lead member of the capacitor 20 of the first embodiment described previously. The method of fabricating members other than the cathode lead member is similar to the method of fabricating the capacitor 20 of the first embodiment.

In the practice of the present invention, the use is preferred of electrolytic etching, chemical etching, blasting or the like to roughen the surface of the aluminum foil. With these processes, the surface of the metal foil can be roughened easily.

Hereinafter, the present invention will be demonstrated by way of examples that are not intended to limit the scope thereof, but are presented for illustrative purpose.

### EXAMPLE 1

An aluminum electrolytic capacitor was made in the following procedure. First, so as to make the anode lead member, an aluminum plain foil was subjected to electrolytic etching in an etching solution containing nitric acid, to roughen the surface. The aluminum foil was then cut to predetermined dimensions. The cathode lead was made by cutting an aluminum plain foil to predetermined dimensions.

After roughing the surface of the aluminum foil and forming the dielectric film on the surface thereof by anodic oxidation at about 520 V, the foil was cut to a width of about 35 mm and a length of about 500 mm, thereby making the anode foil. Then, the anode lead member was attached to the anode foil at a predetermined position thereof.

The cathode foil was made by, after roughing the surface of an aluminum foil and forming a dielectric film on the surface thereof by anodic oxidation at about 2 V, cutting the foil to a width of about 35 mm and a length of about 500 mm. The cathode lead member was then attached to the cathode foil at a predetermined position thereof.

A sheet of Manila paper having a density of 0.50 g/cm³ and a thickness of 50 μm was cut to a width of about 39 mm and a length of about 600 mm to make the separator. A laminate of the anode foil and the cathode foil with the separator placed therebetween was wound to complete the capacitor element. The capacitor element was housed in the container filled with the electrolyte, and the opening of the container was sealed with the sealing body having the rivets for securing the lead members that are drawn from the capacitor element, and was subjected to an aging for one hour with a voltage of 430 V applied thereto. By this aging process, the dielectric films were formed on the surfaces of the anode lead member and cathode lead member, thereby completing the aluminum electrolytic capacitor of Example 1.

### EXAMPLE 2

An aluminum electrolytic capacitor was made in the following procedure. First, to make the anode lead member and the cathode lead member, an aluminum plain foil was subjected to electrolytic etching in an etching solution containing nitric acid, to roughen the surface. The aluminum foil was then cut to predetermined dimensions.

After roughing the surface of the aluminum foil and forming the dielectric film on the surface by anodic oxidation with a voltage of about 520 V, the foil was cut to a width of about 35 mm and a length of about 500 mm, thereby making the anode foil. The anode lead member was then attached to the anode foil at a predetermined position thereof. The cathode foil was made by, after roughing the surface of an aluminum foil and forming the dielectric film on the surface by anodic oxidation with a voltage of about 2 V applied, cutting the foil to a width of about 35 mm and a length of about 500 mm. The cathode lead member was attached to the cathode foil at a predetermined position thereof.

A sheet of Manila paper having a density of 0.50 g/cm³ and a thickness of 50 μm was cut to a width of about 39 mm and a length of about 600 mm to make the separator. A laminate of the anode foil and the cathode foil with the separator placed therebetween was wound to provide the capacitor element. The capacitor element was housed in the container filled with the electrolyte, and the opening of the container was sealed with the sealing body having the rivets for securing the lead members that were drawn from the capacitor element, and was subjected to an aging for one hour with a voltage of 430 V applied. By this aging process, the dielectric films were formed on the surfaces of the anode lead member and the cathode lead member, thereby completing the aluminum electrolytic capacitor of Example 2.

### EXAMPLE 3

An aluminum electrolytic capacitor was made in the following procedure. First, an aluminum plain foil was roughened by employing a blasting process and a dielectric film was formed on the surface by anodic oxidation with a voltage of about 520 V applied, to provide an anode lead member. In the same manner, an aluminum plain foil was roughened by employing a blasting process and a dielectric film was formed on the surface by anodic oxidation with a voltage of about 2 V applied, to make a cathode lead member.

After roughing the surface of the aluminum foil and forming the dielectric film on the surface by anodic oxidation with a voltage of about 520 V applied, the foil was cut to a width of about 35 mm and a length of about 500 mm, thereby making the anode foil. The anode lead member was then attached to the anode foil at a predetermined position thereof. The cathode foil was made by, after roughing the surface of an aluminum foil and forming the dielectric film on the surface by anodic oxidation with a voltage of about 2 V, cutting the foil to a width of about 35 mm and a length of about 500 mm. The cathode lead member was attached to the cathode foil at a predetermined position thereof.

A sheet of Manila paper having a density of 0.50 g/cm³ and a thickness of 50 μm was cut to a width of about 39 mm and a length of about 600 mm to make the separator. A laminate of the anode foil and the cathode foil with the separator placed therebetween was wound to make the capacitor element. The capacitor element was housed in the container filled up with the electrolyte for operating the capacitor, and the opening of the container was sealed with the sealing body having the rivet connected to the lead member that was drawn from the capacitor element, and was subjected to an aging for one hour with a voltage of 430 V applied. By this aging process, the dielectric films were formed on the surfaces of the anode lead member and the cathode lead member. The aluminum electrolytic capacitor of Example 3 was completed in the process described above.

### EXAMPLE 4

An aluminum electrolytic capacitor was made in the following procedure. First, an aluminum plain foil was cut to predetermined dimensions to make the anode lead member and the cathode lead member. After roughing the surface of an aluminum foil, and forming the dielectric film on the surface by anodic oxidation with a voltage of about 520 V, the foil was cut to a width of about 35 mm and a length of about 500 mm, thereby making the anode foil. The anode lead member was attached at the predetermined position of the anode foil and was subjected to chemical etching containing an acidic solution to roughen the surface.

Similarly, after roughing the surface of an aluminum foil and forming the dielectric film on the surface by anodic oxidation of a voltage about 2 V applied, the foil was cut to a width of about 35 mm and a length of about 500 mm, thereby providing the cathode foil. The cathode lead member was then attached to the cathode foil at a predetermined position thereof, and was subjected to chemical etching in an acidic solution to roughen the surface.

A sheet of Manila paper having a density of 0.50 g/cm³ and a thickness of 50 μm was cut to a width of about 39 mm and a length of about 600 mm to make the separator. A laminate of the anode foil and the cathode foil with the separator placed therebetween was wound to make the capacitor element. The capacitor element was housed in the container filled up with the electrolyte for operating the capacitor, and the opening of the container was sealed with the sealing body having rivets connected to the lead members drawn from the capacitor element, and was subjected to an aging for one hour with a voltage of 430 V applied. By this aging process, the dielectric films were formed on the surfaces of the anode lead member and the cathode lead member, thereby completing the aluminum electrolytic capacitor of Example 4.

### Comparative Example

A capacitor of Comparative Example was made for the purpose of comparison between the capacitors of the present invention and the capacitor of the prior art.

The capacitor of this Comparative Example is not subjected to the surface treatment to roughen the surface of the anode lead member. This capacitor was fabricated as described below. First, an aluminum plain foil was subjected to anodic oxidation with a voltage of about 520 V applied, to form a dielectric film on the surface, thereby providing the anode lead member. The anode foil was made by, after roughing the surface of the aluminum foil and forming the dielectric film on the surface by anodic oxidation with a voltage of about 520 V applied, cutting the foil to a width of about 35 mm and a length of about 500 mm. The anode lead member was attached to the anode foil at a predetermined position thereof.

An aluminum plain foil was subjected to anodic oxidation with a voltage of about 520 V applied, to form the dielectric film on the surface thereby completing the cathode lead member. The cathode foil was made by, after applying surface roughing treatment to an aluminum foil and applying anodic oxidation with a voltage of about 2 V to form the dielectric film on the surface, cutting the foil to a width of about 35 mm and a length of about 500 mm. The cathode lead member was attached at the predetermined position of the cathode foil.

A sheet of Manila paper having a density of 0.50 g/cm³ and a thickness of 50 μm was cut to a width of about 40 mm and a length of about 600 mm to make the separator. A laminate of the anode foil and the cathode foil with the separator placed therebetween was wound to provide the capacitor element. The capacitor element was used to make the aluminum electrolytic capacitor of this comparative example in a process similar to the Examples described above.

The capacitors of Examples 1 to 4 and the capacitor of the Comparative Example were compared. The capacitors were subjected to a durability test at an ambient temperature of 85° C. for 20,000 hours under a bias voltage of 350 Vdc and a ripple current of 2A at 120 Hz. The results of the tests are shown in Table 1. In the durability test, the length of time passed before a valve fitted on the container was opened by the effect of a pressure exerted by gases generated inside the container of the capacitor.

TABLE 1

| | Anode lead member | Cathode lead member | Service |
|---|---|---|---|
| | Method of | Method of roughening | life |
| | roughening surface | surface | (Hours) |
| Example 1 | Electrolytic etching | None | Valve did |
| | | | not open |
| Example 2 | Electrolytic etching | Electrolytic etching | Valve did |
| | | | not open |
| Example 3 | Blasting | Blasting | Valve did |
| | | | not open |
| Example 4 | Chemical etching | Chemical etching | Valve did |
| | | | not open |
| Comparative | None | None | 1200 |
| Example | | | |

As shown in Table 1, the valve did not open in any of the aluminum electrolytic capacitors of Examples 1 to 4. This shows that the amounts of gases generated in the capacitors of those examples are less than that of the capacitor of the Comparative Example. This is because the dielectric film formed on the anode lead member surface is stabilized to decrease the leak current, by forming the dielectric film on the surface of the metal foil which has been roughened when making the anode lead member, in the capacitors of those examples. The capacitors of Examples 2 to 4 are more preferable, each of which comprises the anode lead member and the cathode lead member, both including the dielectric films on the metal foil with roughness.

### EXAMPLE 5

In Example 5, a plurality of aluminum electrolytic capacitors were made using different anodizing voltages for forming the anode lead dielectric film on the anode lead member. The capacitors were subjected to durability test similar to that described above. Processes of making the capacitors will be described below.

Capacitor elements were made in the same manners as in Example 2, each having an anode foil connected with an anode lead member, a cathode foil connected with a cathode lead member, and a separator. Both of the anode lead member and the cathode lead member include an aluminum foil which was subjected to electrolytic etching. The capacitor element was housed in a container filled with the electrolyte and an opening of the container was sealed with a sealing body similarly to that in Example 2.

The resultant capacitors were subjected to an aging for one hour, and dielectric films were formed on the anode lead member and the cathode lead member. Voltage applied during the aging was set to 120% (capacitor A), 110% (capacitor B), 80% (capacitor E), 71% (capacitor F), 69% (capacitor G) and 60% (capacitor 1) of the anodizing voltage (520 V) applied when forming the dielectric film on the anode foil.

Results of the service life test on those six capacitors made as described above are shown in Table 2. Also shown in Table 2 are the results of capacitor C (the same voltage as the anodizing voltage used during anodic oxidation of the anode foil was applied during aging) and capacitor D (a voltage equal to 83% of the anodizing voltage used during anodic oxidation of the anode foil was applied during aging) made in Examples 3 and 2, respectively. Also a capacitor element having an anode lead member subjected to the surface roughing treatment by electrolytic etching and a cathode lead member not subjected to the surface roughing treatment was made similarly to Example 1. After aging this capacitor element for one hour at a voltage of value 67% that of the voltage of anodic oxidation (520 V) of the anode foil, the dielectric films were formed on the anode lead member and the cathode lead member to make the capacitor H, the test result of which is also shown in Table 2.

TABLE 2

| | | | | Cathode lead | |
|---|---|---|---|---|---|
| | Anode lead member | | | member | |
| | Voltage of anodic | Proportion to voltage of anodic | Method of | Method of | |
| Capacitor | oxidation (V) | oxidation of anode foil (%) | roughening surface | roughening surface | Service life (Hours) |
| A | 625 | 120 | Electrolytic etching | Electrolytic etching | Valve did not open |
| B | 570 | 110 | Electrolytic etching | Electrolytic etching | Valve did not open |
| C | 520 | 100 | Blasting | Blasting | Valve did not open |
| D | 430 | 83 | Electrolytic etching | Electrolytic etching | Valve did not open |
| E | 415 | 80 | Electrolytic etching | Electrolytic etching | Valve did not open |
| F | 370 | 71 | Electrolytic etching | Electrolytic etching | 18000 |
| G | 360 | 69 | Electrolytic etching | Electrolytic etching | 7000 |
| H | 350 | 67 | Electrolytic etching | None | 5000 |
| I | 310 | 60 | Electrolytic etching | Electrolytic etching | 2000 |

As shown in Table 2, the valve did not open during the period of measurement for the voltage used during anodic oxidation of the anode lead member in a range from 120% to 80% (capacitors A through E) of the voltage of anodic oxidation of the anode foil, while the valve opened when the proportion of voltage was 71% (capacitor F). It was also found that, when the voltage of anodic oxidation of the anode lead member is not equal to or higher than 71% of the voltage of anodic oxidation of the anode foil, service life of the capacitor decreases as the proportion of the voltage of anodic oxidation of the anode lead member to the anode foil decreases. When the voltage of anodic oxidation of the anode lead member is 69% (capacitor G) of the voltage of anodic oxidation of the anode foil, in particular, the period before the valve opens decreases sharply.

Thus, it was found that the proportion of the voltage of anodic oxidation of the anode lead member to the voltage of anodic oxidation of the anode foil is preferably about 70% or greater, and more preferably about 80% or greater. When the proportion is in the above described range, the dielectric film is unlikely to be broken. Since there is a relation of proportionality between the voltage of anodic oxidation and the thickness of the dielectric film, it can be seen that the anode lead member has a dielectric film of thickness preferably about 70%, more preferably about 80%, of the thickness of the dielectric film of the anode foil or greater. When the producing conditions are taken into consideration, the voltage of anodic oxidation of the anode lead member is preferably not higher than or equal to about 200% of the voltage of anodic oxidation of the anode foil.

With the capacitor of the present invention, as described above, since the anode lead member including a first metal core with roughness (that is, surface area of the first metal core is increased) and an anode lead dielectric film deposited on the roughness, the anode lead dielectric film is firmly deposited on the surface of the metal foil, and the anode lead dielectric film is less likely to crack.

If the voltage of the anodic oxidation for forming the anode lead dielectric film is greater than or equal to about 70% of that for the anode foil dielectric film, the dielectric film having a sufficient thickness is formed on the surface of the anode lead member. Thus the anode lead dielectric film is less likely to crack. As a result, the leak current can be suppressed thereby reducing the gas generation.

Also if the anode lead member includes a first metal core with roughness and the anode lead dielectric film deposited on the roughness by anodic oxidation and the cathode lead member includes the second metal core with roughness and the cathode lead dielectric film deposited on the roughness by anodic oxidation, both the anode lead dielectric film and the cathode lead dielectric film are unlikely to be broken. As a result, the leak current can be suppressed thereby reducing the gas generation.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

What is claimed is:

1. A capacitor comprising:
an anode foil having an anode foil dielectric film deposited thereon by anodic oxidation;
an anode lead member including a first metal core with roughness and an anode lead dielectric film deposited on the roughness by anodic oxidation, said anode lead member being electrically connected to said anode foil;
a cathode foil opposing to said anode foil;
a separator interposed between said anode foil and said cathode foil;
a cathode lead member being electrically connected to said cathode foil; and
a container filled up with an electrolyte and containing said anode foil, anode lead member, cathode foil and cathode lead member therein;
wherein a voltage of the anodic oxidation for forming the anode lead dielectric film is greater than or equal to about 70% of that for the anode foil dielectric film.

2. A capacitor according to claim 1, wherein the voltage of the anodic oxidation for forming the anode lead dielectric film is greater than or equal to about 80% of that for the anode foil dielectric film.

3. A capacitor according to claim 1, wherein said cathode foil has a cathode foil dielectric film deposited thereon and said cathode lead member includes a second metal core with roughness and a cathode lead dielectric film deposited on the roughness.

4. A capacitor according to claim 1, wherein the first metal core with roughness is produced by using at least one selected from the group consisting of electrolytic etching method, chemical etching method and blasting method.

5. A capacitor comprising:
an anode foil having an anode foil dielectric film deposited thereon by anodic oxidation;
an anode lead member including a first metal core with roughness and an anode lead dielectric film deposited on the roughness by anodic oxidation, said anode lead member being electrically connected to said anode foil;
a cathode foil opposing to said anode foil;
a separator interposed between said anode foil and said cathode foil,
a cathode lead member including a second metal core with roughness and a cathode lead dielectric film deposited on the roughness by anodic oxidation, said cathode lead member being electrically connected to the cathode foil; and
a container filled up with an electrolyte and containing said anode foil, anode lead member, cathode foil and cathode lead member therein.

6. A capacitor according to claim 5, wherein the voltage of the anodic oxidation for forming the anode lead dielectric film is greater than or equal to about 70% of that for the anode foil dielectric film.

7. A capacitor according to claim 5, wherein the voltage of the anodic oxidation for forming the anode lead dielectric film is about 80% or more than that for the anode foil dielectric film.

8. A capacitor according to claim 5, wherein the first and second metal core with roughness are produced by using at least one selected from the group consisting of electrolytic etching method, chemical etching method and blasting method.

9. A method of producing a capacitor, comprising the steps of:
a) preparing an anode foil having an anode foil dielectric film deposited thereon by anodic oxidation;
b) roughening a first metal core;
c) depositing an anode lead dielectric film on the first metal core by anodic oxidation so as to form an anode lead member;
d) electrically connecting said anode lead member with said anode foil;
e) opposing a cathode foil to said anode foil interposing a separator therebetween;
f) electrically connecting a cathode lead member with said cathode foil; and
g) immersing said anode and cathode foil, and said anode and cathode lead member within a container filled up with an electrolyte;
wherein a voltage of the anodic oxidation for forming the anode lead dielectric film is greater than or equal to about 70% of that for forming the anode foil dielectric film.

10. A method of producing a capacitor according to claim 9, wherein the voltage of the anodic oxidation for forming the anode lead dielectric film is greater than or equal to about 80% of that for forming the anode foil dielectric film.

11. A method of producing a capacitor according to claim 9, wherein said step (b), (d) and (c) are carried out in this order.

12. A method of producing a capacitor according to claim 9, wherein said step (b) is carried out after said step (d).

13. A method of producing a capacitor according to claim 9, wherein said step (b), (c) and (d) are carried out in this order and a condition of the anode oxidation for forming the anode foil dielectric film is as same as that for forming the anode lead dielectric film.

14. A method of producing a capacitor according to claim 9, further comprising the steps of:
h) roughening a second metal core; and
i) depositing a cathode lead dielectric film on the second metal core by anodic oxidation to form a cathode lead member.

15. A method of producing a capacitor according to claim 14, wherein said step (h), (f) and (i) are carried out in this order.

16. A method of producing a capacitor according to claim 14, wherein said step (h) is carried out after said step (f).

17. A method of producing a capacitor according to claim 14, wherein said steps (h), (i) and (f) are carried out in this order and conditions of the anode oxidation for depositing said anode foil dielectric film, said anode lead dielectric film and said cathode lead dielectric film are the same.

18. A method of producing a capacitor according to claim 9, wherein said step (b) is carried out by using at least one selected from the group consisting of electrolytic etching method, chemical etching method and blasting method.
